(19) United States
(12) Patent Application Publication
(10) Pub. No.: US 2025/0252277 A1
(43) Pub. Date: Aug. 7, 2025

(54) Locator Chip Device

(71) Applicant: Mamie Long, Anchorage, AK (US)

(72) Inventor: Mamie Long, Anchorage, AK (US)

(21) Appl. No.: 19/034,702

(22) Filed: Jan. 23, 2025

Related U.S. Application Data
(60) Provisional application No. 63/549,705, filed on Feb. 5, 2024.

(51) Int. Cl. G06K 7/10; G06K 19/07

(52) U.S. Cl. CPC G06K 7/10099; G06K 7/10306; G06K 19/0719; G06K 19/0723

(57) ABSTRACT

A locator chip device is disclosed, which is a color-coded locator chip to be secured to a household or personal item. The locator chip device comprises a chip component that is configured in various shapes and sizes with an adhesive backing. The chip component is secured to an item and a smartphone application allows a user to assign each color of chip to a specific item. If an item is lost, the user selects the corresponding color in the app to locate it. The chip components can also be located via an audible sound or a visual indicator that quickens as one nears the lost item. Additionally, users can use their phone's vibrate feature for assistance. There is no limit as to what items can receive a color-coded chip component. People can place the chip component on the item and track it via the smartphone application with ease.

### CROSS-REFERENCE TO RELATED APPLICATION

The present application claims priority to, and the benefit of, U.S. Provisional Application No. 63/549,705, which was filed on Feb. 5, 2024, and is incorporated herein by reference in its entirety.

### FIELD OF THE INVENTION

The present invention relates generally to the field of locator chip devices. More specifically, the present invention relates to a color-coded locator chip device that can be attached to numerous small, household, and/or personal items for tracking. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in locator chip devices. Generally, searching for commonly misplaced items like keys, television remotes, smartphones, glasses cases, and numerous other items is frustrating. Further, people may have no way of tracking these items, ultimately losing them permanently. Thus, people may spend considerable time looking for these items and end up wasting portions of their day without them.

Additionally, mobile telephones have evolved to be an essential item that most people carry along with their keys and wallets or purses. Mobile phones have also evolved to run multiple applications and contain critical information, such that the loss of a phone can be, as or more detrimental as, losing one's wallet or keys. Currently, preventative solutions for protecting all one's critical items, such as wallets, purses, keys, and/or mobile phones, are either ineffective or cumbersome to use.

Accordingly, there is a demand for an improved locator chip device that can be attached to numerous small, household or personal items for tracking. More particularly, there is a demand for a locator chip device that saves considerable time and effort while searching for lost items.

Therefore, there exists a long felt need in the art for a locator chip device that provides users with a color-coded locator chip that can be attached to numerous small, household or personal items for tracking. There is also a long felt need in the art for a locator chip device that allows users to assign color chips to items in a smartphone application for tracking. Further, there is a long felt need in the art for a locator chip device that enables users to select the corresponding color in the application if an item is lost, sounding an audible alert or providing a visual indicator in the app to locate the item. Moreover, there is a long felt need in the art for a device that prevents people from losing items permanently while saving considerable time and effort during the search. Further, there is a long felt need in the art for a locator chip device that utilizes color-coded chips with adhesive backings to secure to items. Finally, there is a long felt need in the art for a locator chip device that can utilize a cell phone's vibration feature for locating the item.

The subject matter disclosed and claimed herein, in one embodiment thereof, comprises a locator chip device. The device is a color-coded locator chip to be secured to a household or personal item. The locator chip device comprises a chip component that is configured in various shapes and sizes with an adhesive backing. The chip component is secured to an item and a smartphone application allows a user to assign each color of chip to a specific item. If an item is lost, the user selects the corresponding color in the app to locate it. The chip components can also be located via an audible sound or a visual indicator that quickens as one nears the lost item. Additionally, users can use their phone's vibrate feature for assistance. There is no limit as to what items can receive a color-coded chip component. People can place the chip component on the item and track it via the smartphone application with ease.

In this manner, the locator chip device of the present invention accomplishes all of the forgoing objectives and provides users with a device that tracks small personal and household items. The device is a color-coded chip component that is placed on an item to be tracked. The device is tracked via a smartphone application with ease.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a locator chip device. The device is a color-coded locator chip to be secured to a household or personal item. The chip component is secured to an item and a software application installed on a smart device allows a user to assign each color of chip to a specific item. If an item is lost, the user selects the corresponding color in the app to locate it. There is no limit as to what items can receive a color-coded chip component. People can place the chip component on the item and track it via the smartphone application with ease.

In one embodiment, the locator chip device includes a chip component that can be tracked via a software application. The chip component can be any suitable shape and size as is known in the art and is secured to a personal item. The personal item can include a wallet, keys, a car, a bike, a pet, or any other object that the user wants to track. The user can then utilize the software application installed on a smart device to track the chip component and corresponding item.

In one embodiment, the chip component may be a chip, tile, tag, or other device for housing circuitry and that may be attached to or enclosed within an object or personal item, such as a wallet, keys, purse, car, or other object that the user may track. There is no limit as to what items can receive a color-coded chip component. Further, the chip component is color-coded and can be configured in assorted sized shapes. The chip component is attached to one's valuable items such as a belt, a wrist band, jewelry, clothing items, glasses, shoes, watches, hair accessories, luggage, backpacks, portable electronic devices, laptop, a camera, tools or measuring devices, etc. The chip component can be attached through adhesives, mechanically fastening, clipping, gluing, or taping the chip component to the item. The chip component can also be attached to children and pets via a band or collar. Thus, it is an object of the present invention to provide a device and method for preventing the loss of a personal item, such as a wallet, keys, purse, and other high valued items in a means that is precise and uses minimal battery power.

In one embodiment, the locator chip device utilizes a smart phone for tracking personal items. Generally, most people carry smart cell phones and the world is moving toward more and more people having such phones. Thus, the locator chip device uses the smart device as the tracking unit, thereby eliminating the need for a separate unit. Smart phones already have relatively powerful wireless capability, including Bluetooth in most cases, and have programmable controllers that can run third party software, and have long-life battery systems. Thus, the smart device can utilize a software application to track and locate a personal item which has an attached chip component. An exemplary device is described herein, for purposes of disclosure of a working example of the invention. It is to be understood that variations on the described device, such as other wireless protocols, or using other common wireless, programmable devices such as PDA's, will occur to those skilled in the art. The broad invention, as claimed is intended to include such variations.

In one embodiment, users preferably download the software application from the internet and install it onto their smart device although other means are possible. Once installed on the smart device, users preferably access the software application via a user interface.

In one embodiment, it is desirable that this software makes a minimal impact on the power consumption of the smart device. In order to do this the software application will preferably run as a background service still allowing the phone to go to sleep, and only use minimal CPU and Bluetooth while letting the rest of the smart device to power down. When the software application needs to alert the user, it will power up the necessary hardware on the smart device and alert the user. Once it is done it will power back down the hardware to its previous “sleep” power level.

In one embodiment, the chip component includes components such as a microprocessor and transceiver which is compliant and compatible with existing mobile telephone (cellular phone) protocols and infrastructures. By nature, the chip component is a wide area network (WAN)-type component. No local facility or infrastructure, such as readers or local base stations, is needed for operation. The chip component can make use of existing cellular telephone infrastructure and networks to provide operational functionality across wide ranges. In one embodiment, the chip component utilizes a wireless communication protocol or RF standard, such as Bluetooth or an Ultra Low Power (ULP) Bluetooth protocol, or other wireless protocol to enable communication between the smart device and the chip component.

In one embodiment, the chip component incorporates a minimum amount of communications circuitry which may be imbedded or integrated into the chip component. For example, the chip component can minimally include a processor, transceiver, memory, a power source such as a long-life battery or solar cell, and an antenna which is integrated into the chip component, as will be further described. With additional innovations in battery technology, batteries such as lithium-ion batteries can be provided which allows for the chip component to operate for relatively long time periods. In one embodiment, battery life is expected to be about three to five years or longer. Such longer operational periods are made possible because the transceiver need only operate to send and receive a small amount of digital (unconverted) information.

In one embodiment, the chip component comprises an antenna coupled to an RF transceiver device. The transceiver, processor, and memory each receive power from a power source, such as battery. Components such as an antenna, a transceiver, a processor, and a memory can vary according to those known in the art and used in mobile devices such as cell phones. An exemplary chip component may receive an activation signal via the antenna and through the transceiver which is registered by the processor. As a next step, the processor may interrogate the memory for specific identification information assigned in the memory. For example, each chip component is color-coded. The smartphone application allows a user to assign each color of chip component to a specific item. If an item is lost, the user selects the corresponding color in the software application to locate it.

In one embodiment, an exemplary graphical user interface (GUI) of a smart device, such as a cellular phone is used with the software application. The cell phone will also be capable of receiving user input through a user interface such as a touch screen, a keyboard, button pad, or track wheel, which allow user access to the software application. Output is shown on a Graphical Display. In one embodiment, once the location of a mobile chip component is determined, the location information can be directed to the smart device where it is displayed. Display of the smart device shows an exemplary message which may be displayed to an end user to indicate the location of the chip component. Display may include touch selectable menu options, such as a select button, a cancel button, and map button to display a map of the location of the chip component.

In one embodiment, an alert is sounded when a personal item is lost and needing to be tracked. The alert includes the smart phone ringing, vibrating, and/or using a visual means. Further, the chip components can also be located via an audible sound or a visual indicator that quickens as one nears the lost item. Additionally, users can use their phone's vibrate feature for assistance.

In one embodiment, along with using a software application for locating misplaced items, a handheld remote control can also be used similar to the software application. Users will set a beeping sound of their choice to items they tend to lose with the software application and can utilize their smart phone or the remote control to locate the lost items.

In use, a user may purchase a locator chip device which includes at least one chip component. The user can then affix the color-coded chip component to an object, such as a personal item. A software application is downloaded on a user's smart device and coordinates with the chip components. The software application allows users to assign each color of chip component to a specific item. If the item becomes lost, a user logs into the software application to match the color of the chip component within the software application. The user then selects the corresponding color in the software application to locate it. Location information is then sent as tracking signals from the chip component to be interpreted by the cellular infrastructure and sent via the mobile phone protocol, or by other means, such as Bluetooth, to the smart device. As a result, the user has the power to determine a physical location of the item in question in real time, at any time and from virtually any location accessible to the network.

In yet another embodiment, the locator chip device comprises a plurality of indicia.

In yet another embodiment, a method of tracking an item via a smartphone application is disclosed. The method includes the steps of providing a locator chip device comprising at least one chip component. The method also comprises securing the at least one chip component to an item to be tracked. Further, the method comprises logging into a smartphone application on a smart device. The method also comprises tracking a lost item on the smartphone application. Finally, the method comprises locating the item via the smartphone application, wherein an audible sound or a visual indicator alerts a user of the lost item.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the locator chip device of the present invention showing the item to be tracked in accordance with the disclosed architecture;

FIG. 2 illustrates a perspective view of one embodiment of the locator chip device of the present invention showing the smartphone application for tracking the items in accordance with the disclosed architecture;

FIG. 3 illustrates a perspective view of one embodiment of the locator chip device of the present invention showing the device in use in accordance with the disclosed architecture; and

FIG. 4 illustrates a flowchart showing the method of tracking an item via a smartphone application in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a locator chip device that provides users with a color-coded locator chip that can be attached to numerous small, household or personal items for tracking. There is also a long felt need in the art for a locator chip device that allows users to assign color chips to items in a smartphone application for tracking. Further, there is a long felt need in the art for a locator chip device that enables users to select the corresponding color in the application if an item is lost, sounding an audible alert or providing a visual indicator in the app to locate the item. Moreover, there is a long felt need in the art for a device that prevents people from losing items permanently while saving considerable time and effort during the search. Further, there is a long felt need in the art for a locator chip device that utilizes color-coded chips with adhesive backings to secure to items. Finally, there is a long felt need in the art for a locator chip device that can utilize a cell phone's vibration feature for locating the item.

The present invention, in one exemplary embodiment, is a novel locator chip device. The device is a color-coded locator chip to be secured to a household or personal item. The locator chip device comprises a chip component that is configured in various shapes and sizes with an adhesive backing. The chip component is secured to an item and a smartphone application allows a user to assign each color of chip to a specific item. If an item is lost, the user selects the corresponding color in the app to locate it. The chip components can also be located via an audible sound or a visual indicator that quickens as one nears the lost item. The present invention also includes a novel method of tracking an item via a smartphone application. The method includes the steps of providing a locator chip device comprising at least one chip component. The method also comprises securing the at least one chip component to an item to be tracked. Further, the method comprises logging into a smartphone application on a smart device. The method also comprises tracking a lost item on the smartphone application. Finally, the method comprises locating the item via the smartphone application, wherein an audible sound or a visual indicator alerts a user of the lost item.

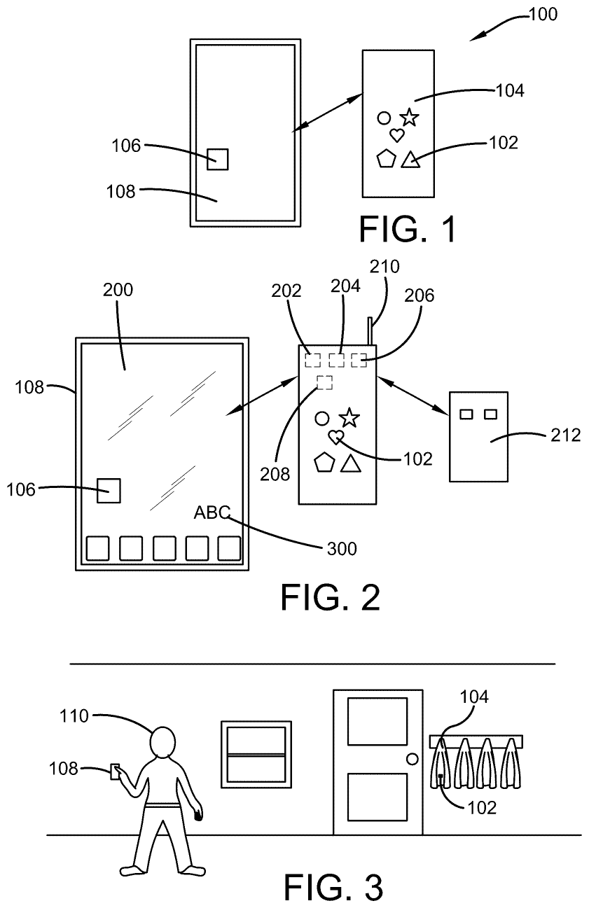

Referring initially to the drawings, FIG. 1 illustrates a perspective view of one embodiment of the locator chip device 100 of the present invention. In the present embodiment, the locator chip device 100 is an improved locator chip device 100 that provides a user with a tracking system for small items. Specifically, the locator chip device 100 comprises a chip component 102 that is secured to a small item 104. A software application 106 installed on a smart device 108 allows a user 110 to assign each color of chip 102 to a specific item 104. If an item 104 is lost, the user 110 selects the corresponding color in the app 106 to locate it. There is no limit as to what items 104 can receive a color-coded chip component 102. Users 110 can place the chip component 102 on the item 104 and track it via the smartphone application 106 with ease.

Generally, the locator chip device 100 includes a chip component 102 that can be tracked via a software application 106. The chip component 102 can be any suitable shape and size as is known in the art and is secured to a personal item 104. The personal item 104 can include a wallet, keys, a car, a bike, a pet, or any other object 104 that the user 110 wants to track. The user 110 can then utilize the software application 106 installed on a smart device 108 to track the chip component 102 and corresponding item 104.

Further, the chip component 102 may be a chip, tile, tag, or other device for housing circuitry and that may be attached to or enclosed within an object or personal item 104, such as a wallet, keys, purse, car, or other object 104 that the user 110 may track. There is no limit as to what items 104 can receive a color-coded chip component 102. Further, the chip component 102 is color-coded and can be configured in assorted sized shapes. The chip component 102 is attached to one's valuable items such as a belt, a wrist band, jewelry, clothing items, glasses, shoes, watches, hair accessories, luggage, backpacks, portable electronic devices, laptop, a camera, tools or measuring devices, etc. The chip component 102 can be attached through adhesives, mechanically fastening, clipping, gluing, or taping the chip component 102 to the item 104. The chip component 102 can also be attached to children and pets via a band or collar. Thus, it is an object of the present invention to provide a device 100 and method for preventing the loss of a personal item 104, such as a wallet, keys, purse, and other high valued items in a means that is precise and uses minimal battery power.

As shown in FIG. 2, the locator chip device 100 utilizes a smart phone 108 for tracking personal items 104. Generally, most people carry smart cell phones 108 and the world is moving toward more and more people having such phones 108. Thus, the locator chip device 100 uses the smart device 108 as the tracking unit, thereby eliminating the need for a separate unit. Smart phones 108 already have a relatively powerful wireless capability, including Bluetooth in most cases, and have programmable controllers that can run third party software, and have long-life battery systems. Thus, the smart device 108 can utilize a software application 106 to track and locate a personal item 104 which has an attached chip component 102. An exemplary device 100 is described herein, for purposes of disclosure of a working example of the invention. It is to be understood that variations on the described device 100, such as other wireless protocols, or using other common wireless, programmable devices such as PDA's, will occur to those skilled in the art. The broad invention, as claimed is intended to include such variations.

Generally, users 110 preferably download the software application 106 from the internet and install it onto their smart device 108 although other means are possible. Once installed on the smart device 108, users 110 preferably access the software application 106 via a user interface. Specifically, an exemplary graphical user interface (GUI) 200 of a smart device 108, such as a cellular phone is used with the software application 106. The cell phone 108 will also be capable of receiving user input through a user interface 200 such as a touch screen, a keyboard, button pad, or track wheel, which allow user access to the software application 106. Output is shown on a Graphical Display. In one embodiment, once the location of a mobile chip component 102 is determined, the location information can be directed to the smart device 108 where it is displayed. Display of the smart device 108 shows an exemplary message which may be displayed to an end user 110 to indicate the location of the chip component 102. Display may include touch selectable menu options, such as a select button, a cancel button, and map button to display a map of the location of the chip component 102, etc.

Further, it is desirable that this software 106 makes a minimal impact on the power consumption of the smart device 108. In order to do this the software application 106 will preferably run as a background service still allowing the phone 108 to go to sleep, and only use minimal CPU and Bluetooth while letting the rest of the smart device 108 to power down. When the software application 106 needs to alert the user 110, it will power up the necessary hardware on the smart device 108 and alert the user 110. Once it is done it will power back down the hardware to its previous “sleep” power level.

Additionally, the chip component 102 includes components such as a microprocessor 202 and transceiver 204 which is compliant and compatible with existing mobile telephone (cellular phone) protocols and infrastructures. By nature, the chip component 102 is a wide area network (WAN)-type component. No local facility or infrastructure, such as readers or local base stations, is needed for operation. The chip component 102 can make use of existing cellular telephone infrastructure and networks to provide operational functionality across wide ranges. In one embodiment, the chip component 102 utilizes a wireless communication protocol or RF standard, such as Bluetooth or an Ultra Low Power (ULP) Bluetooth protocol, or other wireless protocol to enable communication between the smart device 108 and the chip component 102.

Furthermore, the chip component 102 incorporates a minimum amount of communications circuitry which may be imbedded or integrated into the chip component 102. For example, the chip component 102 can minimally include a processor 202, transceiver 204, memory 206, a power source 208 such as a long-life battery or solar cell, and an antenna 210 which is integrated into the chip component 102, as will be further described. With additional innovations in battery technology, batteries 208 such as lithium-ion batteries can be provided which allows for the chip component 102 to operate for relatively long time periods. In one embodiment, battery life is expected to be about three to five years or longer. Such longer operational periods are made possible because the transceiver 204 need only operate to send and receive a small amount of digital (unconverted) information.

Further, the chip component 102 comprises an antenna 210 coupled to an RF transceiver device 204. The transceiver 204, processor 202, and memory 206 each receive power from a power source 208, such as battery. Components such as an antenna 210, a transceiver 204, a processor 202, and a memory 206 can vary according to those known in the art and used in mobile devices such as cell phones 108. An exemplary chip component 102 may receive an activation signal via the antenna 210 and through the transceiver 204 which is registered by the processor 202. As a next step, the processor 202 may interrogate the memory 206 for specific identification information assigned in the memory 206. For example, each chip component 102 is color-coded. The smartphone application 106 allows a user 110 to assign each color of chip component 102 to a specific item 104. If an item 104 is lost, the user 110 selects the corresponding color in the software application 106 to locate it.

Furthermore, an alert is sounded when a personal item 104 is lost and needing to be tracked. The alert includes the smart phone 108 ringing, vibrating, and/or using a visual means. Further, the chip components 102 can also be located via an audible sound or a visual indicator that quickens as one nears the lost item 104. Additionally, users 110 can use their phone's vibrate feature for assistance in tracking the lost item 104.

In one embodiment, along with using a software application 106 for locating misplaced items 104, a handheld remote control 212 can also be used similar to the software application 106. Users 110 will set a beeping sound of their choice to items 104 they tend to lose with the software application 106 and can utilize their smart phone 108 or the remote control 212 to locate the lost items 104.

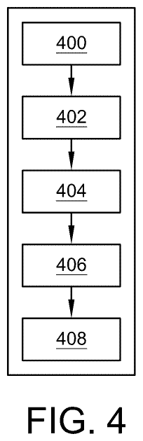

As shown in FIG. 3, in use, a user 110 may purchase a locator chip device 100 which includes at least one chip component 102. The user 110 can then affix the color-coded chip component 102 to an object 104, such as a personal item. A software application 106 is downloaded on a user's smart device 108 and coordinates with the chip components 102. The software application 106 allows users 110 to assign each color of chip component 102 to a specific item 104. If the item 104 becomes lost, a user 110 logs into the software application 106 to match the color of the chip component 102 within the software application 106. The user 110 then selects the corresponding color in the software application 106 to locate it. Location information is then sent as tracking signals from the chip component 102 to be interpreted by the cellular infrastructure and sent via the mobile phone protocol, or by other means, such as Bluetooth, to the smart device 108. As a result, the user 110 has the power to determine a physical location of the item 104 in question in real time, at any time and from virtually any location accessible to the network.

In yet another embodiment, the locator chip device 100 comprises a plurality of indicia 300. The chip component 102 of the device 100 may include advertising, a trademark, or other letters, designs, or characters, printed, painted, stamped, or integrated into the chip component 102, or any other indicia 300 as is known in the art. Specifically, any suitable indicia 300 as is known in the art can be included, such as but not limited to, patterns, logos, emblems, images, symbols, designs, letters, words, characters, animals, advertisements, brands, etc., that may or may not be personal item, smart device, or brand related.

FIG. 4 illustrates a flowchart of the method of tracking an item via a smartphone application. The method includes the steps of at 400, providing a locator chip device comprising at least one chip component. The method also comprises at 402, securing the at least one chip component to an item to be tracked. Further, the method comprises at 404, logging into a smartphone application on a smart device. The method also comprises at 406, tracking a lost item on the smartphone application. Finally, the method comprises at 408, locating the item via the smartphone application, wherein an audible sound or a visual indicator alerts a user of the lost item.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “locator chip device”, “locator device”, “chip device”, and “device” are interchangeable and refer to the locator chip device 100 of the present invention.

Notwithstanding the forgoing, the locator chip device 100 of the present invention can be of any suitable size and configuration as is known in the art without affecting the overall concept of the invention, provided that it accomplishes the above stated objectives. One of ordinary skill in the art will appreciate that the locator chip device 100 as shown in FIGS. 1-4 is for illustrative purposes only, and that many other sizes and shapes of the locator chip device 100 are well within the scope of the present disclosure. Although the dimensions of the locator chip device 100 are important design parameters for user convenience, the locator chip device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A locator chip device that provides a user with a tracking system for personal items, the locator chip device comprising:
a chip component; and
a software application;
wherein the software application is installed on a smart device;
wherein the chip component is color-coded with a specific color and secured to a personal item;
wherein the chip component comprises circuitry and electronics to be tracked by the software application; and
further wherein when the personal item is lost, a user can access the software application to track a location of the personal item via the chip component.

2. The locator chip device of claim 1, wherein the personal item includes a wallet, keys, a purse, a car, a bike, a pet, jewelry, clothing items, glasses, shoes, watches, hair accessories, luggage, backpacks, a camera, tools, a belt, a, remote control, or any other object that the user wants to track.

3. The locator chip device of claim 2, wherein the chip component may be a chip, tile, tag, or other device for housing circuitry and electronics.

4. The locator chip device of claim 3, wherein the chip component is attached through adhesives, mechanically fastening, clipping, gluing, or taping the chip component to the personal item.

5. The locator chip device of claim 4, wherein users preferably download the software application to install it onto their smart device and access the software application via a graphical user interface.

6. The locator chip device of claim 5, wherein the chip component comprises components such as a microprocessor and a transceiver which is compliant and compatible with existing smart device protocols and infrastructures.

7. The locator chip device of claim 6, wherein the chip component utilizes a wireless communication protocol or RF standard, such as Bluetooth or an Ultra Low Power (ULP) Bluetooth protocol, or other wireless protocol to enable communication between the smart device and the chip component.

8. The locator chip device of claim 7, wherein the chip component comprises a memory, a battery, and an antenna.

9. The locator chip device of claim 8, wherein the transceiver, the microprocessor, and the memory each receive power from the battery.

10. The locator chip device of claim 9, wherein the chip component may receive an activation signal via the antenna and through the transceiver which is registered by the microprocessor, and the microprocessor may interrogate the memory for specific identification information assigned in the memory, such as assigned colors of the chip component.

11. The locator chip device of claim 10, wherein an alert is sounded when the personal item is lost and needing to be tracked.

12. The locator chip device of claim 11, wherein a remote control can be used to locate the personal item instead of the software application downloaded on their smart device.

13. The locator chip device of claim 12, wherein the chip component can be located via an audible sound, a vibration, or a visual indicator that quickens as a user nears a lost personal item.

14. A locator chip device that provides a user with a tracking system for personal items, the locator chip device comprising:
a color-coded chip component with an adhesive backing which secures to a personal item; and
a software application installed on a smart device;
wherein the personal item includes a wallet, keys, a purse, a car, a bike, a pet, jewelry, clothing items, glasses, shoes, watches, hair accessories, luggage, backpacks, a camera, tools, a belt, a, remote control, or any other object that the user wants to track;
wherein the chip component comprises components such as a microprocessor, a transceiver, a memory, a battery, and an antenna, which are compliant and compatible with existing smart device protocols and infrastructures;
wherein the chip component utilizes a wireless communication protocol or RF standard, such as Bluetooth or an Ultra Low Power (ULP) Bluetooth protocol, or other wireless protocol to enable communication between the smart device and the chip component;
wherein the chip component may receive an activation signal via the antenna and through the transceiver which is registered by the microprocessor, and the microprocessor may interrogate the memory for specific identification information assigned in the memory, such as assigned colors of the chip component;
wherein when the personal item is lost, a user can access the software application to track a location of the personal item via the chip component and color-coding within the software application;
wherein an alert is sounded when the personal item is lost and needing to be tracked; and
further wherein the chip component can be located via an audible sound, a vibration, or a visual indicator that quickens as a user nears a lost personal item.

15. The locator chip device of claim 14, wherein the chip component may be a chip, tile, tag, or other device for housing circuitry and electronics.

16. The locator chip device of claim 14, wherein users preferably download the software application to install it onto their smart device and access the software application via a graphical user interface.

17. The locator chip device of claim 14, wherein the transceiver, the microprocessor, and the memory each receive power from the battery.

18. The locator chip device of claim 14, wherein the alert includes the smart device ringing, vibrating, or using a visual means.

19. The locator chip device of claim 14 further comprising a plurality of indicia.

20. A method of tracking an item via a smartphone application, the method comprising the following steps:
providing a locator chip device comprising at least one chip component;
securing the at least one chip component to an item to be tracked;
logging into a smartphone application on a smart device;
tracking a lost item on the smartphone application; and
locating the item via the smartphone application, wherein an audible sound or a visual indicator alerts a user of the lost item.
